(19) United States
(12) Patent Application Publication
(10) Pub. No.: US 2014/0266732 A1
(43) Pub. Date: Sep. 18, 2014

(54) HAND HYGIENE COMPLIANCE SYSTEM

(71) Applicants: Theodore R. Barbeau, Cheshire, CT (US); Thomas Robert Barbeau, Ludlow, MA (US); Benjamin Danker, Branford, CT (US); Douglas Drew Papuga, Branford, CT (US); Tristan Ramas, West Haven, CT (US); Richard Riggott, Broad Brook, CT (US)

(72) Inventors: Theodore R. Barbeau, Cheshire, CT (US); Thomas Robert Barbeau, Ludlow, MA (US); Benjamin Danker, Branford, CT (US); Douglas Drew Papuga, Branford, CT (US); Tristan Ramas, West Haven, CT (US); Richard Riggott, Broad Brook, CT (US)

(21) Appl. No.: 14/212,687

(22) Filed: Mar. 14, 2014

Related U.S. Application Data
(60) Provisional application No. 61/793,977, filed on Mar. 15, 2013.

(51) Int. Cl. G08B 21/02

(52) U.S. Cl. CPC G08B 21/02
USPC 340/573.1

(57) ABSTRACT

A system for monitoring and reporting personnel compliance with usage of an antiseptic dispenser for hand hygiene. The system may be provided in each of a plurality of rooms in a building. For example, patient rooms in a hospital may each be equipped with the system. The system is configured to detect and identify persons entering or exiting a room, to monitor the persons' use of an antiseptic dispenser, and to report the persons' use of the antiseptic dispenser.

### CROSS REFERENCE TO RELATED APPLICATION

This application claims the benefit of U.S. Provisional Application No. 61/793,977, filed Mar. 15, 2013.

### TECHNICAL FIELD AND BACKGROUND

The present application relates to a system for hand hygiene compliance. More specifically, the present application relates to a system for monitoring the use of an antiseptic dispenser.

### SUMMARY

In one embodiment, a system for monitoring hand hygiene compliance includes an antiseptic dispenser configured to detect when antiseptic has been dispensed and to generate a corresponding dispensation signal. The system also includes a compliance subsystem configured to detect when a person enters a room, the compliance subsystem also being configured to generate an audio message and/or a visual message to instruct the person entering the room to use the antiseptic dispenser, and the compliance subsystem being further configured to terminate the audio message and/or the visual message in response to the dispensation signal received from the antiseptic dispenser.

In another embodiment, a system for monitoring hand hygiene compliance includes an antiseptic dispenser configured to detect when antiseptic has been dispensed and to generate a corresponding dispensation signal, a personal ID device adapted to be carried by a person entering a room, the personal ID device being configured to generate an ID signal identifying the person carrying the personal ID device, and a compliance subsystem in communication with the antiseptic dispenses and the personal ID device. The compliance subsystem being configured to detect the ID signal of the personal ID device of the person entering the room and to add the person identified by the ID signal to a stored list of people who need to use the antiseptic dispenser.

In one embodiment, a computer-implemented method for monitoring hand hygiene compliance includes detecting an ID signal of a personal ID device carried by person entering a room, adding the person identified by the detected ID signal to a stored list of people who need to use the antiseptic dispenser, receiving a dispensation signal from an antiseptic dispenser indicating that antiseptic has been dispensed, detecting the ID signal of the personal ID device of the person to whom the antiseptic is dispensed, associating the ID signal of the personal ID device of the person to whom the antiseptic is dispensed with the dispensation signal received from the antiseptic dispenser, and removing person identified by the ID signal associated with the dispensation signal from the stored list of people who need to use the antiseptic dispenser.

### BRIEF DESCRIPTION OF THE DRAWINGS

The foregoing summary, as well as the following detailed description of the preferred embodiments, is better understood when read in conjunction with the appended drawings. For the purpose of illustrating the invention, exemplary embodiments are shown in the drawings. It should be understood, however, that the invention is not limited to the specific embodiments disclosed. In the drawings:

FIG. 1 shows the installation of an exemplary embodiment of a system for hand-hygiene compliance;

FIG. 2 shows an exemplary schematic diagram of an exemplary embodiment of the system shown in FIG. 1;

FIG. 3 shows an exemplary schematic diagram of another exemplary embodiment of the system shown in FIG. 1;

FIG. 4 shows an exemplary data flow hierarchy of the exemplary system of FIG. 3

FIG. 5 shows the installation of an exemplary embodiment of a system for hand-hygiene compliance;

FIG. 6 shows an exemplary schematic diagram of an exemplary embodiment of the system shown in FIG. 5;

FIG. 7 shows an exemplary schematic diagram of another exemplary embodiment of the system shown in FIG. 5;

FIG. 8 shows a flow chart of an exemplary implementation of a system for hand-hygiene compliance;

FIG. 9 shows a flow chart of another exemplary implementation of a system for hand-hygiene compliance; and

FIG. 10 shows a flow chart of still another exemplary implementation of a system for hand-hygiene compliance.

### DETAILED DESCRIPTION

Before the various embodiments are described in further detail, it is to be understood that the invention is not limited to the particular embodiments described. It is also to be understood that the terminology used is for the purpose of describing particular embodiments only, and is not intended to limit the scope of the claims of the present application.

In accordance with one aspect of the invention, provided is a system 100 for hand hygiene compliance. The system 100 may be installed throughout a building to monitor people's compliance with hand hygiene requirements. In one embodiment, as shown in FIG. 1, the system 100 may comprise a compliance subsystem 120, an antiseptic dispenser 140 and a personal ID device 160. As shown if FIG. 1, a plurality of compliance subsystems 120 and antiseptic dispensers 140 can be provided throughout a plurality of rooms 10 in a building, e.g., patient rooms in a hospital. The compliance subsystems 120 are adapted to detect when an associated antiseptic dispenser 140 has dispensed antiseptic. As shown, each compliance subsystem 120 may have an associated antiseptic dispenser 140 with which the compliance subsystem 120 communicates via a wired or wireless connection. However, it should be understood that a compliance subsystem 120 may be associated with and in communication with a plurality of antiseptic dispensers 140. Further, it should also be understood that although the compliance subsystem 120 and antiseptic dispenser 140 are shown in the figures as separate devices, the compliance subsystem 120 and antiseptic dispenser 140 may be integrated into a single device. The various components/subsystems of the system 100 may be connected to a battery power source, direct power source, other suitable power source, or any combination thereof.

A compliance subsystem 120 may be installed in each room 10 in which hand hygiene compliance is to be monitored, and positioned within the room 10 such that the compliance subsystem 120 can identify the persons with personal ID devices 160 who are entering or exiting the room 10. Persons whose hand hygiene compliance needs to be monitored may carry a personal ID device 160 encoded with a unique identifier corresponding to each person, which can be tracked by the compliance subsystems 120. For example, as shown in FIG. 2, the compliance subsystem 120 may be positioned near an entrance 12 of a room 10 so that the personal ID devices 160 are within range of the compliance subsystem 120 and can be detected by the compliance subsystem 120 as persons enter or exit the room. The personal ID devices 160 may be configured to communicate with compliance subsystems 120 via a wireless communication network so that the compliance subsystem 120 may detect and identify persons entering or exiting a room 10 and monitor their use of an antiseptic dispenser 140. Further, the compliance subsystems 120 are adapted to detect when an associated antiseptic dispenser 140 has dispensed antiseptic. Accordingly, the compliance subsystems 120 may track the movement of persons with personal ID devices 160 and monitor their use of antiseptic dispensers 140.

The compliance subsystem 120 may comprise a computer system 121, an LCD display 122, LED lights 123, speakers 124, self-checking circuitry 125. The computer system 121 may be any suitable computer, such as a microcontroller, comprising a microprocessor 126, memory 127, communication module 128, and input/output (I/O) facilities 129. The communication module 128 may be configured to communicate with the personal ID devices 160 of persons who are entering or exiting the room 10 via any suitable wireless communication network (e.g., a Local Area Network (LAN) implementing communication protocols such as BLUETOOTH®, WI-FI®, ZIGBEE®, Ethernet, etc.). Although the communication module 128 is shown in the drawings as an integrated part of the computer system 121, it should be understood that the communication module 128 may be implemented as a peripheral device connected to the computer system 121. When the communication module 128 of the computer system 121 receives a signal from the personal ID device 160 indicating that a person has entered the room 10, the computer system 121 can generate an audio signal, which can be transmitted to one or more speakers 124 in the room 10, to alert the person entering the room to use the antiseptic dispenser 140. Also, the computer system 121 can generate a signal to activate lights (e.g., LED lights 123) and/or display a message (e.g., message on an LCD display 122) to further alert the person entering the room to use the antiseptic dispenser 140.

The self-checking circuitry 125 of the compliance subsystem 120 may be configured to check for errors with the antiseptic dispenser 140, such as an open door latch on the antiseptic dispenser 140, a low battery level, a low antiseptic fluid level, a faulty LCD display, a faulty LED light, and air sensed in the antiseptic dispenser 140 preventing antiseptic from being dispensed. The self-checking circuitry 125 may comprise various types of sensors for checking system errors, including a door latch sensor 130, a battery charge sensor 131, an antiseptic fluid level sensor 132 (e.g., IR sensor), and an air sensor 133. The self-checking circuitry 125 may be programmed to run a check-error routine on a predetermined schedule. If the self-checking circuitry 125 detects any system errors, an appropriate message may be displayed on the LCD display 122 and/or an appropriate LED light may be activated.

In accordance with one embodiment, as shown in FIG. 2, the antiseptic dispenser 140 may comprise a container 141 (e.g., bottle, bag) containing antiseptic fluid, a pump 142, a tube 143 connecting the container to the pump and a dispensation sensor 144 for sensing when antiseptic has been dispensed. The antiseptic dispenser 140 may be a manual dispenser comprising a lever mechanism 145 for actuating the pump 142 to dispense antiseptic fluid. The antiseptic dispenser 140 may be configured such that the forward action of the lever mechanism 145 dispenses antiseptic fluid from a reservoir 146 having a predefined volume, and the reverse action of the lever mechanism 145 refills the reservoir 146 and readies the next dispensing of antiseptic fluid. In a manual antiseptic dispenser 140, the dispensation sensor 144 may configured to detect the pumping action of the pump 142, movement of antiseptic fluid through the tube 143/reservoir 146, movement of the lever mechanism 145 or other suitable action for determining when antiseptic fluid has been dispensed.

Alternatively, as shown in FIG. 2, the antiseptic dispenser 140 may be an automatic dispenser further comprising a hand-sensing device 147 and control circuitry 148 to actuate the pump 142 to dispense antiseptic fluid. For example, the hand-sensing device 147 may be any suitable sensor, such as an infrared sensor, that is adapted to detect the presence of a hand at the antiseptic dispenser 140. When the hand-sensing device 147 is triggered, a signal can be generated to the control circuitry 148 to actuate the pump 142 to dispense antiseptic fluid. For example, in response to a signal from the hand-sensing device 147, the control circuitry 148 may actuate a solenoid 149 to move a lever mechanism 145, which causes the pump 142 to dispense antiseptic fluid. The antiseptic dispenser 140 may be configured such that the forward action of the lever mechanism 145 dispenses antiseptic fluid from a reservoir 146 having a predefined volume, and the reverse action of the lever mechanism 145 refills the reservoir 146 and readies the next dispensing of antiseptic fluid. In an automatic antiseptic dispenser 140, the dispensation sensor 144 may configured to detect the pumping action of the pump 142, movement of antiseptic fluid through the tube 143/reservoir 146, movement of the lever mechanism 145, actuation of the solenoid 149, signaling of the hand-sensing device 147 or other suitable action for determining when antiseptic fluid has been dispensed.

As show in the embodiment of FIG. 2, the antiseptic dispenser 140 may comprise a microcontroller 150 with a communication module 151 for communicating with the communication module 128 of the computer system 121. The communication module 151 of the antiseptic dispenser 140 and the communication module 128 of the computer system 121 may be configured to communicate via any suitable communication network (e.g., a Local Area Network (LAN) implementing communication protocols such as BLUETOOTH®, WI-FI®, ZIGBEE®, Ethernet, etc.). The microcontroller 150 may be adapted to generate a signal indicating that antiseptic fluid has been dispensed and to send the signal, via the communication module 151, to the compliance subsystem 120. It should also be understood, however, that although the compliance subsystem 120 and antiseptic dispenser 140 have been shown and described as separate devices, the compliance subsystem 120 and antiseptic dispenser 140 may be integrated into a single device. Accordingly, in some embodiments, the compliance subsystem 120 and antiseptic dispenser 140 may be directly connected and not require communication via communication network. For example, in one embodiment, the dispensation sensor 144 may be connected to the input/output (I/O) facilities 129 of the computer system 121 to transmit signals (e.g., signals indicating that antiseptic fluid has been dispensed).

As shown in FIG. 2, the compliance subsystem 120 may be configured to receive signals from the dispensation sensor 144 indicating that antiseptic fluid has been dispensed and cease any alerts generated by the computer system 121. For example, when the computer system 121 receives a signal from the dispensation sensor 144 indicating that antiseptic fluid has been dispensed, the computer system 121 can terminate the audio signal alerting the person entering the room to use the antiseptic dispenser 140. Also, the computer system 121 can terminate the signal to activate lights (e.g., LED lights 123) and/or display a message (e.g., message on an LCD display 122) alerting the person entering the room to use the antiseptic dispenser 140.

In one embodiment, the personal ID device 160 may comprise a communication module 161, a microcontroller 162 and a battery 163. The communication modules 161 of the personal ID devices 160 may be adapted to communicate with the communication modules 128 of the compliance subsystems 120, so that the movement of persons with personal ID devices 160 can be tracked and their use of antiseptic dispensers 140 can be monitored. For example, in one embodiment, the communication module 161 of the personal ID device 160 may be a radio-frequency device, such as Nebusens' N-CORE® Sirius Quantum device, and the communication module 128 of the compliance subsystem 120 may be a radio-frequency device, such as Nebusens' N-CORE® Sirius D device, which are adapted to communicate with each other via a wireless network based on the IEEE 802.15.4/ZIGBEE® international standard.

The microcontroller 162 of the personal ID device 160 may be programmed with information to be transmitted to the compliance subsystems 120. For instance, the microcontroller 162 of the personal ID device 160 may be programmed to transmit to the compliance subsystems 120 whether the person is staff or patient. Accordingly, if a person present in the room 10 is identified as a patient, the compliance subsystem 120 may go into “active mode” to monitor staff entering the room 10 and their compliance with hand hygiene standards. Alternatively, if the compliance subsystem 120 does not detect a patient in the room, it may go into “standby mode.” Also, the microcontroller 162 of the personal ID device 160 may be programmed to transmit to the compliance subsystems 120 a unique identifier corresponding to a person. Further, the microcontroller 162 of the personal ID device 160 may be programmed to communicate to the compliance subsystems 120 whether that person needs to comply with hand hygiene standards, whether that person does not need to comply with hand hygiene standards, or whether that person should not use the antiseptic dispenser 140. If a person is identified as someone needing to comply with hand hygiene standards, the compliance subsystem 120 will alert the person to use the antiseptic dispenser 140 and will indicate that person's use or non-use of the antiseptic dispenser 140. If a person is identified as someone not needing to comply with hand hygiene standards, the compliance subsystem 120 will not alert the person to use the antiseptic dispenser 140 and will not indicate that person's use or non-use of the antiseptic dispenser 140, but will allow that person to use the antiseptic dispenser 140. In some cases, it may be deemed that use of antiseptic may be inappropriate for some persons (e.g., pediatric patients or other patients deemed at risk through a clinical evaluation process). Accordingly, if a person in the room 10 is identified as someone who should not use the antiseptic dispenser 140, the compliance subsystem 120 may temporarily disable the antiseptic dispenser 140 to prevent use of the antiseptic dispenser 140.

In some embodiments, the personal ID device 160 may be configured for use by patients and may further comprise a gyroscope/accelerometer 164 and/or a help button 165. The gyroscope/accelerometer 164 may be adapted to measure velocity and orientation, and the microcontroller 162 may be programmed so that if a measured velocity is indicative of a patient falling, a signal is sent to the compliance subsystem 120 indicating that the patient has fallen. Further, the microcontroller 162 may be programmed so that if the help button 165 is pressed, a signal is sent to the compliance subsystem 120 indicating that the patient requires assistance. In other embodiments, the personal ID device 160 may be configured for use by staff and may comprise a null button 166. The microcontroller 162 may be programmed so that if the null button 166 is pressed, a signal is sent to the compliance subsystem 120 indicating that the staff person is already in compliance.

In another embodiment, as shown in FIG. 3, the system 100 may be further configured for monitoring and reporting personnel compliance with usage of an antiseptic dispenser 140 for hand hygiene. Certain components and subsystems of the embodiment of system 100 shown in FIG. 2 are substantially the same as the embodiment of system 100 described with reference to FIG. 3. The embodiment of system 100 shown in FIG. 3, however, includes additional components for monitoring and reporting personnel compliance with usage of the antiseptic dispenser 140 for hand hygiene. In the drawings, like reference numerals refer to like features of the systems and methods of the present application. Accordingly, although certain descriptions may use reference numerals with reference to only certain figures, it should be understood that such descriptions might be equally applicable to like reference numerals in other figures. For example, certain descriptions refer only to FIG. 2; however, it should be understood that those descriptions are equally applicable to like reference numerals shown in FIG. 3.

As shown in FIG. 3, the compliance subsystem 120 may be configured to communicate with a local server 172 and/or a remote server 173 via the communication module 128 of the computer system 121 in order to report personnel compliance with usage of the antiseptic dispenser 140 and to report system errors detected by the self-checking circuitry 125. For instance, the compliance subsystem 120 may transmit to the local server and/or remote server information including, but not limited to identifying information about a person (e.g., unique identifier from personal ID device or name, etc.), time the person entered room, time antiseptic was dispensed to the person, and time the person exited the room. In addition to compliance data, the compliance subsystem 120 may communicate data regarding battery usage, antiseptic fluid usage, other device errors, and personnel traffic.

In some embodiments, as shown in FIGS. 1 and 3, the system 100 may comprise a communication coordinating device 170 for providing a communication link between the local server 172 and/or the remote server 173 and the compliance subsystems 120 and the personal ID devices 160. For example, at least one communication coordinating device 170 may be installed per floor of a building so that the communication-coordinating device 170 can communicate with the compliance subsystems 120 installed on that floor of the building and the personal ID devices 160 of the persons located on that floor of the building. Each communication coordinating device 170 on a building floor can then communicate information received from the compliance subsystems 120 and the personal ID devices 160 to the local server 172 and/or the remote server 173. Further, in some embodiments, as shown in FIGS. 1 and 3, the system 100 may comprise a signal repeater 171 for providing a communication link between the compliance subsystems 120 and the personal ID devices 160 and the communication coordinating device 170.

As shown in FIG. 3, the communication coordinating device 170 and signal repeater 171 may be configured to communicate with the compliance subsystems 120 and the personal ID devices 160 via any suitable communication network (e.g., a Local Area Network (LAN) implementing communication protocols such as BLUETOOTH®, WI-FI®, ZIGBEE®, Ethernet, etc.). Further, as shown in FIG. 3, the communication-coordinating device 170 may be configured to communicate with the local server 172 and/or the remote server 173 via a communication network 174. The communication 174 network may be may be one or a combination of two or more of a Local Area Network (LAN), a Metropolitan Area Network (MAN), a Wide Area Network (WAN), a proprietary network, a Public Switched Telephone Network (PSTN), a Wireless Application Protocol (WAP) network, a BLUETOOTH® network, WI-FI® network, a ZIGBEE® network, a wireless LAN network, an Internet Protocol (IP) network such as the Internet, an intranet, or an extranet, and/or other suitable communication network.

For example, in one embodiment, the communication module 161 of the personal ID device 160 may be a radio-frequency device, such as Nebusens' N-CORE® Sirius Quantum device. The communication module 128 of the compliance subsystem 120 may be a radio-frequency device, such as Nebusens' N-CORE® Sirius D device. The communication coordinating device 170 may be a radio-frequency device, such as Nebusens' N-CORE® Sirius A device. The signal repeater 171 may be a radio-frequency device, such as Nebusens' N-CORE® Sirius D device. In this exemplary embodiment, the radio-frequency devices are adapted to communicate with each other via a wireless network based on the IEEE 802.15.4/ZIGBEE® international standard.

FIG. 4 shows an exemplary data flow hierarchy between various components of the exemplary system 100 of FIG. 3. The local server 172 may be configured to communicate with the various compliance subsystems 120 located throughout a building floor, an entire building or complex of buildings and process compliance data and system-error data received from the various compliance subsystems 120. For example, the local server 172 may be configured to: send messages (e.g., phone messages, email messages, etc.), including messages to parties responsible for equipment maintenance in response to system error messages; generate trend data, including regarding system usage in order to determine whether more antiseptic dispensers 140 are needed and where; and generate and send reports, including generating and sending non-compliance reports to hospital administration about specific persons. In some embodiments, as shown in FIG. 3, the compliance subsystems 120 and/or the local server 172 may communicate with a remote server 173 via the communication network 174 such that the remote server may perform one or more tasks described above in connection with the local server 172.

The compliance system 120 monitors personnel compliance with usage of the antiseptic dispenser 140 by detecting personal ID devices 160 within range during certain events. For instance, when the compliance subsystem 120 receives a signal from a personal ID device 160 indicating that a person has entered the room 10, the computer system 121 of the compliance subsystem 120 may store the unique identifier associated with the personal ID device 160 that was read to a list stored in the memory 127 that tracks all of the persons in the room.

Further, the computer system 121 may communicate with the local server 172 and/or the remote server 173 to determine whether a person entering the room needs to comply with hand hygiene standards, whether that person does not need to comply with hand hygiene standards, whether that person should not use the antiseptic dispenser 140, or whether that person is a patient. If the person entering the room needs to comply with hand hygiene standards, the unique identifier read from the personal ID device along with an entrance time stamp is added to a list stored in the memory 127 that tracks all of the persons waiting to use the antiseptic dispenser 140. If after a specified amount of time (e.g., 15 seconds), the computer system 121 has not received indication that a person on the list of persons waiting to use the antiseptic dispenser 140 has used the antiseptic dispenser 140 or has otherwise complied with hand hygiene standards, the computer system 121 can play an audio message over the speakers 124, activate the LED lights 123 and/or display a message on the LCD display 122 to alert the person to use the antiseptic dispenser 140. If the person entering the room does not need to comply with hand hygiene standards, nothing is done other than adding the unique identifier read from the personal ID device to the list stored in the memory 127 that tracks all of the persons in the room. If the person entering the room should not use the antiseptic dispenser 140, the unique identifier read from the personal ID device is added to a list stored in the memory 127, which lists persons who should not use the antiseptic dispenser 140. If the person entering the room is a patient, the unique identifier read from the personal ID device is added to the list stored in the memory 127 that tracks all of the persons in the room. When there is no patient in the list of the persons in the room, the computer system 121 can put the system 100 into “standby mode.” If the system 100 is in “standby mode” and the compliance subsystem 120 reads a unique identifier associated with a patient entering the room, the computer system 121 can put the system 100 into “active mode.” Accordingly, power can be conserved when the monitoring and compliance system 100 does not need to be in “active mode.”

When the hand-sensing device 147 of the antiseptic dispenser 140 is triggered by a person's hand, the microcontroller 150 can generate a hand-sensing signal and transmit the hand-sensing signal to the computer system 121. When the compliance subsystem 120 receives the hand-sensing signal from the antiseptic dispenser 140, the compliance subsystem 120 may read the personal ID device 160 of the person at the antiseptic dispenser 140 (i.e., person closest to the antiseptic sensor 140). When the computer system 121 determines the unique identifier from the detected personal ID device 160 signal, the computer system 121 checks the lists stored in the memory 127 to determine whether the person is permitted to use the antiseptic dispenser 140. If the person is permitted to use the antiseptic dispenser 140, the computer system 121 will generate a signal to the antiseptic dispenser 140 to dispense antiseptic. If the person is not permitted to use the antiseptic dispenser 140, the computer system 121 will generate a signal to the antiseptic dispenser 140 to not dispense antiseptic.

Once antiseptic is dispensed, the antiseptic dispenser 140 may transmit a signal to the compliance subsystem 120. When the compliance subsystem 120 receives a signal from the dispensation sensor 144 of the antiseptic sensor 140 indicating that antiseptic fluid has been dispensed, the computer system 121 checks the list of persons waiting to use the antiseptic dispenser 140. If the unique identifier associated with the personal ID device 160 of the person at the antiseptic sensor 140 (i.e., person closest to the antiseptic sensor 140) is on the list of persons waiting to use the antiseptic dispenser 140, it is removed from the list. The computer system 121 may further determine whether antiseptic was dispensed to the person within a specified amount of time after that person entered the room 10 by checking the entrance time stamp on the list stored in the memory 127. If antiseptic was dispensed to the person within the specified amount time, the computer system 121 may transmit a message to a local or remote server indicating that the person is in compliance with hand hygiene standards. Alternatively, the computer system 121 may simply transmit a message to the local or remote server indicating the unique identifier of the person's personal ID device, the time the person entered the room and the time antiseptic was dispensed to the person, which can be used by the local or remote server to determine whether the person is in compliance with hand hygiene standards.

Also, a staff person may be removed from the list of persons waiting to use the antiseptic dispenser 140 by indicating at the antiseptic dispenser 140 that the staff person is already in compliance (e.g., has recently used the antiseptic dispenser 140 in another room). For example, in one embodiment, a staff person may press the null button 166 of the personal ID device 160 to send a signal to the compliance subsystem 120 indicating that the staff person is already in compliance.

When the compliance subsystem 120 receives a signal from the personal ID device 160 indicating that the person is already in compliance, the computer system 121 may remove the person from the list of persons waiting to use the antiseptic dispenser 140. The computer system 121 may further transmit a message to the local server 172 or remote server 173 indicating the unique identifier of the person's personal ID device, the time the person entered the room and that the person was already in compliance. The local server 172 or remote server 173 can check stored records to confirm that the person was already in compliance at the time the person entered the room.

When the compliance subsystem 120 receives a signal from the personal ID device 160 indicating that a person is exiting the room 10, the compliance subsystem 120 may read the personal ID device 160 of the person exiting the room 10. The computer system 121 may then determine the unique identifier associated with the personal ID device 160 that was read and remove the unique identifier from the list stored in the memory 127 that tracks the persons in the room. Further, the computer system 121 checks whether the unique identifier read from the personal ID device 160 is on the list stored in the memory 127 that tracks the persons waiting to use the antiseptic dispenser 140. If the person exiting the room is on the list of persons waiting to use the antiseptic dispenser 140, the computer system 121 removes the unique identifier from the list stored in the memory 127 that tracks the persons waiting to use the antiseptic dispenser 140. Further, the computer system 121 may generate a message to the local server 172 or remote server 173 indicating the unique identifier of the person's personal ID device 160, the time the person entered and exited the room and that the person was not in compliance.

In another embodiment, as shown in FIGS. 5 and 6, the system 100 further comprises an entryway subsystem 180. As shown in FIGS. 5 and 6, the entryway subsystem 180 may be adapted to detect whether a person has entered or exited the room 10 and to transmit a signal to the compliance subsystem 120 indicating whether a person has entered or exited the room 10. The entryway subsystem 180 may comprise an entryway sensor 181 positioned at the entrance 12 of the room 10 and configured to detect when a person has entered or exited the room 10. Any suitable sensor, such as conventional infrared (IR) sensors, may be used as the entryway sensor 181. In one embodiment, for example, the entryway sensor 181 may comprise an IR emitter 182 and an IR receiver 183, which are positioned across the entrance 12 to detect when a person is entering or exiting the room 10. The IR emitter 182 emits an IR beam that is received by the IR receiver 183. When a person walks across the entrance 12, the IR beam is interrupted and the entryway subsystem 180 generates an IR beam interruption signal. In one embodiment, as shown in FIGS. 5 and 6, the IR emitter 182 and the IR receiver 183 may be positioned across the entrance 12 on opposite sides of the entrance (i.e., inside and outside of the entrance). This particular arrangement of the IR emitter 182 and the IR receiver 183 provides a different IR beam interruption pattern when a person is entering the room 10 than when a person is exiting the room 10. Accordingly, using this arrangement of the IR emitter 182 and the IR receiver 183, the entryway subsystem 180 can generate different IR beam interruption signals depending on whether a person is entering or exiting the room 10.

In another embodiment (not shown), the entryway sensor 181 may comprise two pairs of IR emitters 182 and IR receivers 183 that may be used to detect when a person is entering or exiting the room 10. For example, a first pair of IR emitter 182 and IR receiver 183 may be positioned across the entrance 12 on the outside of the room 10, and a second pair of IR emitter 182 and IR receiver 183 may be positioned across the entrance 12 on the inside of the room 10. Accordingly, when the IR beam of the first pair of IR emitter 182 and IR receiver 183 is interrupted before the second pair, the entryway subsystem 180 can generate an IR beam interruption signal indicating a person entering the room. And when the IR beam of the second pair of IR emitter 182 and IR receiver 183 is interrupted before the first pair, the entryway subsystem 180 can generate an IR beam interruption signal indicating a person exiting the room.

In one embodiment, as shown in FIG. 6, the entryway subsystem 180 may comprise a microcontroller 184 with a communication module 185 for communicating with a communication module 128 of the compliance subsystem 120. The communication module 185 of the entryway subsystem 180 and the communication module 128 of the compliance subsystem 120 may be configured to communicate via any suitable communication network (e.g., a Local Area Network (LAN) implementing communication protocols such as BLUETOOTH®, WI-FI®, ZIGBEE®, Ethernet, etc.). The microcontroller 184 may be adapted to generate the IR beam interruption signal and send the IR beam interruption signal, via the communication module 185, to the compliance subsystem 120 when a person has entered or exited the room 10. Alternatively, the entryway sensor 181 may be connected to the input/output (I/O) facilities 129 of the computer system 121 to transmit the IR beam interruption signal indicating that a person has entered or exited the room 10.

In another embodiment (not shown), the entryway subsystem 180 may be configured as a first unit comprising an IR emitter 182 and a microcontroller 184A with a communication module 185A, and a second unit comprising an IR receiver 183 and a microcontroller 184B with a communication module 185B. The communication modules 185A, 185B of the first and second units of the entryway subsystem 180 and the communication module 128 of the compliance subsystem 120 may be configured to communicate via any suitable communication network (e.g., a Local Area Network (LAN) implementing communication protocols such as BLUETOOTH®, WI-FI®, ZIGBEE®, Ethernet, etc.). The microcontrollers 184A, 184B of the first and second units of the entryway subsystem 180 may be adapted to generate the IR beam signals and send the IR beam signals, via the communication modules 185A, 185B, to the compliance subsystem 120 so that the computer system 121 can determine when a person has entered or exited the room 10. Alternatively, the IR emitter 182 and IR receiver 183 may be connected to the input/output (I/O) facilities 129 of the computer system 121 to transmit the IR beam signals to the compliance subsystem 120 so that the computer system 121 can determine when a person has entered or exited the room 10.

In some embodiments, as shown in FIG. 6, the communication module 128 of the compliance subsystem 120 may be configured to communicate with the entryway subsystem 180 and receive IR beam interruption signals. The communication module 128 of the computer system 121 and the entryway subsystem 180 may be configured to communicate via any suitable communication network (e.g., a Local Area Network (LAN) implementing communication protocols such as BLUETOOTH®, WI-FI®, ZIGBEE®, Ethernet, etc.). When the computer system 121 receives a signal from the entryway subsystem 180 indicating that a person has entered the room 10, the computer system 121 can generate an audio signal, which can be transmitted to one or more speakers 124 in the room 10, to alert the person entering the room to use the antiseptic dispenser 140. Also, the computer system 121 can generate a signal to activate lights (e.g., LED lights 123) and/or display a message (e.g., message on an LCD display 122) to further alert the person entering the room to use the antiseptic dispenser 140.

As shown in FIG. 6, the compliance subsystem 120 may be configured to receive signals from the dispensation sensor 144 indicating that antiseptic fluid has been dispensed and cease any alerts generated by the computer system 121. For example, when the computer system 121 receives a signal from the dispensation sensor 144 indicating that antiseptic fluid has been dispensed, the computer system 121 can terminate the audio signal alerting the person entering the room to use the antiseptic dispenser 140. Also, the computer system 121 can terminate the signal to activate lights (e.g., LED lights 123) and/or display a message (e.g., message on an LCD display 122) alerting the person entering the room to use the antiseptic dispenser 140.

In some embodiments, as shown in FIG. 7, the system 100 may be further configured for monitoring and reporting personnel compliance with usage of an antiseptic dispenser 140 for hand hygiene. For example, the system 100 may be configured to detect and identify persons entering or exiting the room 10, and monitor those persons' use of the antiseptic dispenser 140 depending on who they are.

Certain components and subsystems of the embodiment of system 100 shown in FIG. 6 are substantially the same as those of the embodiment of the system 100 described with reference to FIG. 7. The embodiment of system 100 shown in FIG. 7, however, includes additional components for monitoring and reporting personnel compliance with usage of the antiseptic dispenser 140 for hand hygiene. In the drawings, like reference numerals refer to like features of the systems and methods of the present application. Accordingly, although certain descriptions may refer only to certain figures and reference numerals, it should be understood that such descriptions might be equally applicable to like reference numerals in other figures. For example, certain descriptions refer only to reference numerals shown in FIG. 6; however, it should be understood that those descriptions are equally applicable to like reference numerals shown in FIG. 7.

The system 100 may be configured to identify the persons entering the room 10 by reading a unique personal ID device 160 carried by each person. For example, in one embodiment, the personal ID device 160 may comprise an RFID tag that is encoded with a unique identifier corresponding to that person. Alternatively, other suitable identification means may be used, such as a bar code encoded with a unique identifier for each person. By reading the personal ID device 160 of a person entering the room 10, the system 100 can determine whether that person needs to comply with hand hygiene standards, whether that person does not need to comply with hand hygiene standards, or whether that person should not use the antiseptic dispenser 140. If a person is identified as someone needing to comply with hand hygiene standards, the system 100 will alert the person to use the antiseptic dispenser 140 and will report that person's use or non-use of the antiseptic dispenser 140. If a person is identified as someone not needing to comply with hand hygiene standards, the system 100 will not alert the person to use the antiseptic dispenser 140 and will not report that person's use or non-use of the antiseptic dispenser 140, but will allow that person to use the antiseptic dispenser 140. If a person is identified as someone who should not use the antiseptic dispenser 140, the system 100 will not allow that person to use the antiseptic dispenser 140. If a person is identified as a patient, the system 100 with turn on if the system 100 is in “standby mode.”

As shown in FIG. 7, the compliance subsystem 120 may be configured to communicate with a local server and/or a remote server via the communication module 128 of the computer system 121 in order to report personnel compliance with usage of the antiseptic dispenser 140 and to report system errors detected by the self-checking circuitry 125. For instance, the compliance subsystem 120 may transmit to the local server and/or remote server information including, but not limited to identifying information about a person (e.g., unique identifier from personal ID device or name, etc.), time the person entered room, time antiseptic was dispensed to the person, and time the person exited the room. In addition to compliance data, the compliance subsystem 120 may communicate data regarding battery usage, antiseptic fluid usage, other device errors, and personnel traffic.

In one embodiment, as shown in FIG. 7, the compliance subsystem 120 may be connected to a local server 172 by a communication network 174. The communication 174 network may be may be one or a combination of a Local Area Network (LAN), a Metropolitan Area Network (MAN), a Wide Area Network (WAN), a proprietary network, a Public Switched Telephone Network (PSTN), a Wireless Application Protocol (WAP) network, a BLUETOOTH® network, WI-FI® network, a ZIGBEE® network, a wireless LAN network, an Internet Protocol (IP) network such as the Internet, an intranet, or an extranet, and/or other suitable communication network. The local server 172 may be configured to communicate with various compliance subsystems 120 located throughout a building floor, an entire building or complex of buildings and process compliance data and system-error data received from the various systems 100. For example, the local server 172 may be configured to: send messages (e.g., phone messages, email messages, etc.), including messages to parties responsible for equipment maintenance in response to system error messages; generate trend data, including regarding system usage in order to determine whether more antiseptic dispensers 140 are needed and where; and generate and send reports, including generating and sending non-compliance reports to hospital administration about specific persons. In some embodiments, as shown in FIG. 7, the compliance subsystem 120 and/or the local server 172 may communicate with a remote server 173 via the communication network 174 such that the remote server may perform one or more tasks described above in connection with the local server 172.

Also, as shown in FIG. 7, the compliance subsystem 120 may further comprise an ID device reader 134 to identify persons entering and exiting the room 10. The ID device reader 134 is adapted to read a personal ID device 160 carried by a person entering the room. For example, each person may carry a personal ID device 160 comprising an RFID tag that is encoded with a unique identifier corresponding to that person. Alternatively, other suitable identification means may be used, such as a bar code encoded with a unique identifier for each person. Accordingly, the ID device reader 134 may be an RFID reader, a bar code reader, or other suitable means for reading a personal ID device 160 depending on the type of devices carried by the persons being monitored. The ID device reader 134 may be connected to the input/output (I/O) facilities 129 of the computer system 121 to transmit a personal ID device 160 signal indicating the unique identifier associated with the personal ID device 160 that was read. Alternatively, the ID device reader 134 and the computer system 121 may be configured to communicate via any suitable communication network (e.g., a Local Area Network (LAN) implementing communication protocols such as BLUETOOTH®, WI-FI®, ZIGBEE®, Ethernet, etc.).

The compliance system 120 may monitor personnel compliance with usage of the antiseptic dispenser 140 by activating the ID device reader 134 during certain events. For instance, when the compliance subsystem 120 receives a signal from the entryway subsystem 180 indicating that a person has entered the room 10, the compliance subsystem 120 may activate the ID device reader 134 to read the personal ID device 160 of the person entering the room 10. When the ID device reader 134 transmits to the computer system 121 an personal ID device 160 signal indicating the unique identifier associated with the personal ID device 160 that was read, the computer system 121 adds the unique identifier to a list stored in the memory 127 that tracks all of the persons in the room.

Further, the computer system 121 may communicate with a local or remote server to determine whether the person entering the room needs to comply with hand hygiene standards, whether that person does not need to comply with hand hygiene standards, whether that person should not use the antiseptic dispenser 140, or whether that person is a patient. If the person entering the room needs to comply with hand hygiene standards, the unique identifier read from the personal ID device 160 along with an entrance time stamp is added to a list stored in the memory 127 that tracks all of the persons waiting to use the antiseptic dispenser 140. If after a specified amount of time (e.g., 15 seconds), the computer system 121 has not received indication that a person on the list of persons waiting to use the antiseptic dispenser 140 has used the antiseptic dispenser 140 or has otherwise complied with hand hygiene standards, the computer system 121 can play an audio message over the speakers 124, activate the LED lights 123 and/or display a message on the LCD display 122 to alert the person to use the antiseptic dispenser 140.

If the person entering the room does not need to comply with hand hygiene standards, nothing is done other than adding the unique identifier read from the personal ID device 160 to the list stored in the memory 127 that tracks all of the persons in the room. If the person entering the room should not use the antiseptic dispenser 140, the unique identifier read from the personal ID device 160 is added to a list stored in the memory 127, which lists persons who should not use the antiseptic dispenser 140. If the person entering the room is a patient, the unique identifier read from the personal ID device 160 is added to the list stored in the memory 127 that tracks all of the persons in the room. When there is no patient in the list of the persons in the room, the computer system 121 can put the system 100 into “standby mode.” If the system 100 is in “standby mode” and the ID device reader 134 reads a unique identifier associated with a patient entering the room, the computer system 121 can put the system 100 into “active mode.” Accordingly, power can be conserved when the monitoring and compliance system 100 does not need to be in “active mode.”

When the hand-sensing device 147 of the antiseptic dispenser 140 is triggered, the microcontroller 150 can generate a hand-sensing signal and transmit the hand-sensing signal to the computer system 121. When the compliance subsystem 120 receives the hand-sensing signal from the antiseptic dispenser 140, the compliance subsystem 120 may activate the ID device reader 134 to read the personal ID device 160 of the person at the antiseptic dispenser 140 (i.e., person closest to the antiseptic sensor 140). When the ID device reader 134 transmits to the computer system 121 an personal ID device 160 signal indicating the unique identifier associated with the personal ID device 160 that was read, the computer system 121 checks the lists stored in the memory 127 to determine whether the person is permitted to use the antiseptic dispenser 140. If the person is permitted to use the antiseptic dispenser 140, the computer system 121 will generate a signal to the antiseptic dispenser 140 to dispense antiseptic. If the person is not permitted to use the antiseptic dispenser 140, the computer system 121 will generate a signal to the antiseptic dispenser 140 to not dispense antiseptic.

Once antiseptic is dispensed, the antiseptic dispenser 140 may transmit a signal to the compliance subsystem 120. When the compliance subsystem 120 receives a signal from the dispensation sensor 144 of the antiseptic sensor 140 indicating that antiseptic fluid has been dispensed, the computer system 121 checks the list of persons waiting to use the antiseptic dispenser 140. If the unique identifier associated with the personal ID device 160 of the person at the antiseptic sensor 140 (i.e., person closest to the antiseptic sensor 140) is on the list of persons waiting to use the antiseptic dispenser 140, it is removed from the list. The computer system 121 may further determine whether antiseptic was dispensed to the person within a specified amount of time after that person entered the room 10 by checking the entrance time stamp on the list stored in the memory 127. If antiseptic was dispensed to the person within the specified amount time, the computer system 121 may transmit a message to a local or remote server indicating that the person is in compliance with hand hygiene standards. Alternatively, the computer system 121 may simply transmit a message to the local or remote server indicating the unique identifier of the person's personal ID device 160, the time the person entered the room and the time antiseptic was dispensed to the person, which can be used by the local or remote server to determine whether the person is in compliance with hand hygiene standards.

Also, a person may be removed from the list of persons waiting to use the antiseptic dispenser 140 by indicating at the antiseptic dispenser 140 that the person is already in compliance (e.g., has recently used the antiseptic dispenser 140 in another room). For example, in one embodiment, a person may tap the personal ID device 160 on the antiseptic dispenser 140 so that the personal ID device 160 is read to indicate that the person is already in compliance. In another embodiment, the person may press a button on the antiseptic dispenser 140 so that the personal ID device 160 is read to indicate that the person is already in compliance. The antiseptic dispenser 140 may then transmit a signal to the compliance subsystem 120 indicating that the person is already in compliance. When the compliance subsystem 120 receives a signal from the antiseptic dispenser 140 indicating that the person is already in compliance, the computer system 121 may remove the person from the list of persons waiting to use the antiseptic dispenser 140. The computer system 121 may further transmit a message to the local or remote server indicating the unique identifier of the person's personal ID device 160, the time the person entered the room and that the person was already in compliance. The local or remote server can check stored records to confirm that the person was already in compliance at the time the person entered the room.

When the compliance subsystem 120 receives a signal from the entryway subsystem 180 indicating that a person is exiting the room 10, the compliance subsystem 120 may activate the ID device reader 134 to read the personal ID device 160 of the person exiting the room 10. When the ID device reader 134 transmits to the computer system 121 a personal ID device 160 signal indicating the unique identifier associated with the personal ID device 160 that was read, the computer system 121 removes the unique identifier from the list stored in the memory 127 that tracks the persons in the room. Further, the computer system 121 checks whether the unique identifier read from the personal ID device 160 is on the list stored in the memory 127 that tracks the persons waiting to use the antiseptic dispenser 140. If the person exiting the room is on the list of persons waiting to use the antiseptic dispenser 140, the computer system 121 removes the unique identifier from the list stored in the memory 127 that tracks the persons waiting to use the antiseptic dispenser 140. Further, the computer system 121 may generate a message to the local or remote server indicating the unique identifier of the person's personal ID device 160, the time the person entered and exited the room and that the person was not in compliance.

While the system 100 has been described with reference to various embodiments, it should be understood that the various embodiments described may be modified without departing from the spirit and scope of the invention as a whole. For example, in the embodiments described, components of the system 100 may be added, removed, modified or combined.

An exemplary implementation of the system 100 may be described with reference to the flow chart shown in FIG. 8. In FIG. 8, as shown in block 200, the compliance subsystem 120 detects a person entering the room 10. At block 202, the compliance subsystem 120 then turns on the antiseptic dispenser 140, the LCD display 122, the LED lights 123, and ID device reader 134. At block 204, the ID device reader 134 reads the personal ID device 160 of the person entering the room 10 and transmits a personal ID device 160 signal to the computer system 121 indicating the unique identifier associated with the personal ID device 160 that was read. At block 206, the computer system 121 determines whether the personal ID device 160 is the device of a staff person who needs to comply with hand hygiene standards. The computer system 121 may make this determination by communicating with the local or remote server and/or referencing the local memory 127. If at block 206, the computer system 121 determines that the personal ID device 160 is not a staff person's device, at block 208, the computer system 121 adds the person (e.g., patient) to the list stored in the memory 127 of people present in the room. In one embodiment, the steps of block 202 may be performed after the steps of block 206, so that system 100 can be turned on after it has been determined that a patient has entered the room 10.

If at block 210, the computer system 121 determines that the personal ID device 160 is the device of a staff person who needs to comply with hand hygiene standards, the computer system 121 adds the person to the list stored in the memory 127 of people waiting to use the antiseptic dispenser 140. At block 212, the computer system 121 identifies and displays the person's name or unique identifier in the LCD display 122 to alert the person to use the antiseptic dispenser 140. Further, at block 214, the computer system 121 activates the LED lights 123 to alert the person to use the antiseptic dispenser 140.

At block 216, the antiseptic dispenser 140 determines whether the hand-sensing device 147 has been triggered. If the hand-sensing device 147 of the antiseptic dispenser 140 has been triggered, the antiseptic dispenser 140 initializes a “hand-sensed” status at block 218. At block 220, if the “hand-sensed” status has not been initialized for longer than a predetermined amount of time, the antiseptic dispenser 140 nulls the “hand-sensed” status at block 221. At block 220, if the “hand-sensed” status has been initialized for longer than a predetermined amount of time, the microcontroller 150 of the antiseptic dispenser 140 can generate a hand-sensing signal and transmit the hand-sensing signal to the computer system 121. At block 222, when the compliance subsystem 120 receives the hand-sensing signal from the antiseptic dispenser 140, the compliance subsystem 120 may read the personal ID device 160 of the person at the antiseptic dispenser 140 (i.e., person closest to the antiseptic sensor 140). At block 224, if the unique identifier associated with the personal ID device 160 of the person at the antiseptic sensor 140 (i.e., person closest to the antiseptic sensor 140) is on the list of persons waiting to use the antiseptic dispenser 140, the computer system 121 removes the person from the list. At block 226, the computer system 121 may transmit a message to a local or remote server indicating the unique identifier of the person's personal ID device 160, the time the person entered the room and that the person is in compliance with hand hygiene standards. At block 228, the computer system 121 generates a signal to the antiseptic dispenser 140 to dispense antiseptic and the antiseptic dispenser 140 dispenses the antiseptic.

If, at block 216, the hand-sensing device 147 of the antiseptic dispenser 140 has not been triggered, at block 230, the computer system 121 will check whether the person has indicated that he or she is already in compliance. If, at block 230, the computer system 121 determines that the person has indicated that he or she is already in compliance, the computer system 121 proceeds to remove the person from the list of people waiting to use the antiseptic dispenser 140, as shown in block 224. If, at block 230, the computer system 121 determines that there is no indication that the person is already in compliance, the computer system 121 proceeds to block 232. At block 232, if after a specified amount of time (e.g., 15 seconds), the computer system 121 has not received indication that a person on the list of persons waiting to use the antiseptic dispenser 140 has used the antiseptic dispenser 140 or has otherwise complied with hand hygiene standards, the computer system 121 may generate a message to the local or remote server indicating the unique identifier of the person's personal ID device 160, the time the person entered the room and that the person was not in compliance. Further, the computer system 121 may activate the LED lights 123 on the antiseptic dispenser 140, as shown in block 214.

Another exemplary implementation of the system 100 may be described with reference to the flow chart shown in FIG. 9. In FIG. 9, as shown in block 300, the compliance subsystem 120 detects a person exiting the room 10. At block 302, the compliance subsystem 120 reads the personal ID device 160 of the person exiting the room 10 and transmits a personal ID device 160 signal to the computer system 121 indicating the unique identifier associated with the personal ID device 160 that was read. At block 304, the computer system 121 determines whether the person exiting the room is on the list of people waiting to use the antiseptic dispenser 140. If the person exiting the room 10 is not on the list of people waiting to use the antiseptic dispenser 140, the computer system 121 proceeds to block 306 and determines whether there is any person remaining on the list of people waiting to use the antiseptic dispenser 140. If there is no person remaining on the list of people waiting to use the antiseptic dispenser 140, the antiseptic dispenser 140 is put in “standby mode” at block 308.

If at bock 304, the computer system 121 determines that the person exiting the room is on the list of people waiting to use the antiseptic dispenser 140, the computer system 121 removes the person from the list at block 310. Further, at block 312, the computer system 121 may generate a message to the local or remote server indicating the unique identifier of the person's personal ID device 160, the time the person entered the room and that the person was not in compliance. Additionally, at block 314, the computer system 121 may activate the LED lights 123 on the antiseptic dispenser 140 to alert the person to use the antiseptic dispenser 140.

Yet another exemplary implementation of the system 100 may be described with reference to the flow chart shown in FIG. 10. FIG. 10 shows an exemplary implementation of the self-checking circuitry 125 of the compliance subsystem 120. The self-checking circuitry 125 is configured to check for errors within the system 100, such as an open door latch on the antiseptic dispenser 140, a low battery level, a low antiseptic fluid level, a faulty LCD display, a faulty LED light, and air sensed in the antiseptic dispenser 140 preventing antiseptic from being dispensed. The self-checking circuitry 125 may comprise various types of sensors for checking system errors, including a door latch sensor 130, a battery charge sensor 131, an antiseptic fluid level sensor 132, and an air sensor 133. The self-checking circuitry 125 may be programmed to run a check-error routine on a predetermined schedule. If the self-checking circuitry 125 detects any system errors, the computer system 121 may display an appropriate message on the LCD display 122, may activate appropriate LED light alerts, may send an appropriate message to the local or remote server, and/or may shut down one or more of the components of the system 100.

At block 400, the computer system 121 determines whether the LED lights 123 have an output voltage. If the computer system 121 does not detect an output voltage for the LED lights 123, the computer system 121 will send an error message to the local or remote server (block 401) and display an error message on the LCD display 122 (block 402).

At block 410, the computer system 121 determines whether the door latch on the antiseptic dispenser 140 is open. If the door latch on the antiseptic dispenser 140 is open, the computer system 121 will send an error message to the local or remote server (block 411), display an error message on the LCD display 122 (block 412), and shut down all system 100 components except the computer system 121, LCD display 122, LED lights 123, and communication module 128 (block 413). Further, the computer system 121 will clear the list of people in the room.

At block 420, the computer system 121 determines whether the battery is sufficiently charged. If the battery is not sufficiently charged, the computer system 121 will send an error message to the local or remote server (block 421), display an error message on the LCD display 122 (block 422), and shut down all system 100 components and clear the list of people in the room (block 423).

At block 430, the computer system 121 determines whether the antiseptic level is acceptable. If the antiseptic level is not acceptable, the computer system 121 will send an error message to the local or remote server (block 431), display an error message on the LCD display 122 (block 432), and shut down all system 100 components except the computer system 121, LCD display 122, LED lights 123, and communication module 128 (block 433). Further, the computer system 121 will clear the list of people in the room.

At block 440, the computer system 121 determines whether the entryway sensor 181 has an output voltage. If the entryway sensor 181 does not have an output voltage, the computer system 121 will send an error message to the local or remote server (block 441), display an error message on the LCD display 122 (block 442), and shut down all system 100 components except the computer system 121, LCD display 122, LED lights 123, and communication module 128 (block 443). Further, the computer system 121 will clear the list of people in the room.

At block 450, the computer system 121 determines whether the air sensor is working. If the air sensor is not working, the computer system 121 will send an error message to the local or remote server (block 451), display an error message on the LCD display 122 (block 452), and shut down all system 100 components except the computer system 121, LCD display 122, LED lights 123, and communication module 128 (block 453). Further, the computer system 121 will clear the list of people in the room.

At block 460, the computer system 121 determines whether the hand-sensing device 147 has an output voltage. If the hand-sensing device 147 does not have an output voltage, the computer system 121 will send an error message to the local or remote server (block 461), display an error message on the LCD display 122 (block 462), and shut down all system 100 components except the computer system 121, LCD display 122, LED lights 123, and communication module 128 (block 463). Further, the computer system 121 will clear the list of people in the room.

At block 470, the computer system 121 determines whether the LCD display 122 is working. If the LCD display 122 is not working, the computer system 121 will send an error message to the local or remote server (block 471).

At block 480, the computer system 121 determines whether a program card was swiped. If a program card was swiped, the location of the device ID is reprogrammed on the local or remote server. At block 481, the device ID is displayed on the LCD display 122.

At block 490, the computer system determines whether the check time is on a predetermined time interval. If the check time is on the predetermined time interval, the computer system 121 sends a message to the local or remote server to confirm that the compliance subsystem 120 is online (block 491).

While various embodiments have been described, it will be appreciated by those of ordinary skill in the art that modifications can be made to the various embodiments without departing from the spirit and scope of the invention as a whole.

What is claimed is:

1. A system for monitoring hand hygiene compliance, comprising:
an antiseptic dispenser configured to detect when antiseptic has been dispensed and to generate a corresponding dispensation signal; and
a compliance subsystem configured to detect when a person enters a room; the compliance subsystem being configured to generate an audio message and/or a visual message to instruct the person entering the room to use the antiseptic dispenser, the compliance subsystem being configured to terminate the audio message and/or the visual message in response to the dispensation signal received from the antiseptic dispenser.

2. The system of claim 1 further comprising a personal ID device adapted to be carried by the person entering the room, the personal ID device being configured to generate an ID signal identifying the person carrying the personal ID device;
wherein the compliance subsystem is further configured to detect the ID signal of the personal ID device of the person entering the room and to add the person identified by the ID signal to a stored list of people who need to use the antiseptic dispenser.

3. The system of claim 2, wherein the compliance subsystem is further configured to detect the ID signal of the personal ID device of the person to whom the antiseptic is dispensed and to associate the ID signal with the dispensation signal received from the antiseptic dispenser;
wherein the compliance subsystem is further configured to remove the person identified by the ID signal associated with the dispensation signal from the stored list of people who need to use the antiseptic dispenser.

4. The system of claim 3, wherein the compliance subsystem is further configured to detect when the person exits the room.

5. The system of claim 4, wherein the compliance subsystem is further configured to detect the ID signal of the personal ID device of the person exiting the room;
wherein the compliance subsystem is further configured to check whether the person exiting the room identified by the ID signal is on the stored list of people who need to use the antiseptic dispenser.

6. The system of claim 5, wherein the compliance subsystem sends a non-compliance message to a server, which identifies the person exiting the room who has not used the antiseptic dispenser.

7. The system of claim 1, wherein the compliance subsystem comprises a radio frequency device adapted to communicate via a wireless network based on the IEEE 802.15.4/ZIGBEE® international standard.

8. A system for monitoring hand hygiene compliance, comprising:
an antiseptic dispenser configured to detect when antiseptic has been dispensed and to generate a corresponding dispensation signal;
a personal ID device adapted to be carried by a person entering a room, the personal ID device being configured to generate an ID signal identifying the person carrying the personal ID device;
a compliance subsystem in communication with the antiseptic dispenses and the personal ID device;
wherein the compliance subsystem is configured to detect the ID signal of the personal ID device of the person entering the room and to add the person identified by the ID signal to a stored list of people who need to use the antiseptic dispenser.

9. The system of claim 8, wherein the compliance subsystem is configured to detect the ID signal of the personal ID device of the person to whom the antiseptic is dispensed and to associate the ID signal with the dispensation signal received from the antiseptic dispenser.

10. The system of claim 9, wherein the compliance subsystem is configured to remove the person identified by the ID signal associated with the dispensation signal from the stored list of people who need to use the antiseptic dispenser.

11. The system of claim 10, wherein the sensor is further configured to detect when the person exits the room.

12. The system of claim 11, wherein the compliance subsystem is further configured to detect the ID signal of the personal ID device of the person exiting the room.

13. The system of claim 12, wherein the compliance subsystem is further configured to check whether the person exiting the room identified by the ID signal is on the stored list of people who need to use the antiseptic dispenser.

14. The system of claim 13, wherein the microcontroller sends a non-compliance message to a server, which identifies the person exiting the room who has not used the antiseptic dispenser.

15. A computer-implemented method for monitoring hand hygiene compliance, comprising:
detecting, by a compliance computer system, an ID signal of a personal ID device carried by person entering a room;
adding, by the compliance computer system, the person identified by the detected ID signal to a stored list of people who need to use the antiseptic dispenser;
receiving, by the compliance computer system, a dispensation signal from an antiseptic dispenser indicating that antiseptic has been dispensed;
detecting, by the compliance computer system, the ID signal of the personal ID device of the person to whom the antiseptic is dispensed;
associating, by the compliance computer system, the ID signal of the personal ID device of the person to whom the antiseptic is dispensed with the dispensation signal received from the antiseptic dispenser; and
removing, by the compliance computer system, the person identified by the ID signal associated with the dispensation signal from the stored list of people who need to use the antiseptic dispenser.

16. The method of claim 15 further comprising:
detecting, by the compliance computer system, the ID signal of the personal ID device of the person exiting the room; and
checking, by the compliance computer system, whether the person exiting the room identified by the ID signal is on the stored list of people who need to use the antiseptic dispenser.

17. The method of claim 16 further comprising:
sending, by the compliance computer system, a non-compliance message to a server that identifies the person exiting the room who has not used the antiseptic dispenser.

18. The method of claim 15 further comprising:
determining, by the compliance computer system, whether a specified amount of time has transpired from the time the person entered the room and the time antiseptic was dispensed to the person.

19. The method of claim 18 further comprising:
sending, by the compliance computer system, a non-compliance message to a server identifying the person who is not compliant.

20. The method of claim 18 further comprising:
generating, by the compliance computer system, an alert instructing the person to use the antiseptic dispenser.
